(19) United States
(12) Patent Application Publication
(10) Pub. No.: US 2020/0321715 A1
(43) Pub. Date: Oct. 8, 2020

(54) TERMINAL-EQUIPPED ELECTRIC WIRE AND TERMINAL CRIMPING DEVICE

(71) Applicant: Yazaki Corporation, Tokyo (JP)

(72) Inventors: Hirotaka Takeda, Shizuoka (JP); Kei Sato, Shizuoka (JP)

(21) Appl. No.: 16/802,561

(22) Filed: Feb. 27, 2020

(30) Foreign Application Priority Data
Apr. 3, 2019 (JP) 2019-071077

(51) Int. Cl. H01R 4/18; H01R 43/048; H01R 4/20

(52) U.S. Cl. CPC H01R 4/185; H01R 4/20; H01R 43/048

(57) ABSTRACT

A terminal-equipped electric wire includes: an electric wire; and a crimp terminal including a core wire crimp portion crimped to a core wire of the electric wire, in which the core wire crimp portion includes: a bottom wall portion; and crimping pieces that extend in a direction intersecting the bottom wall portion from an end of the bottom wall portion in a width direction and that are wound around the core wire, a cross-sectional shape of the crimping piece is a curved shape convex toward a side opposite to the bottom wall portion, and curved portions of the crimping piece respectively include protrusions formed to protrude stepwise with respect to surrounding portions.

### CROSS-REFERENCE TO RELATED APPLICATION(S)

The present application claims priority to and incorporates by reference the entire contents of Japanese Patent Application No. 2019-071077 filed in Japan on Apr. 3, 2019.

### BACKGROUND OF THE INVENTION

### 1. Field of the Invention

The present invention relates to a terminal-equipped electric wire and a terminal crimping device.

### 2. Description of the Related Art

Conventionally, there have been techniques for crimping a terminal to an electric wire. Japanese Patent Application Laid-open No. 2010-80194 discloses a technique of a terminal crimping device having a crimper including: a main body on which a sliding contact surface is formed; and a contact portion. The contact portion of Japanese Patent Application Laid-open No. 2010-80194 protrudes from the main body in both directions in which the electric wire extends, and further protrudes inward in a direction intersecting the sliding contact surface, and comes in contact with a wire barrel piece from both sides in an electric wire extending direction when the wire barrel piece is crimped to a core wire. The terminal crimping device of Japanese Patent Application Laid-open No. 2010-80194 is supposed to be able to suppress an increase in the length of the terminal fitting in the electric wire extending direction before and after crimping.

Here, there is still room for improvement in suppressing the lengthening of the crimp terminal due to crimping.

### SUMMARY OF THE INVENTION

An object of the present invention is to provide a terminal-equipped electric wire and a terminal crimping device capable of suppressing lengthening of the crimp terminal due to crimping.

In order to achieve the above mentioned object, a terminal-equipped electric wire according to one aspect of the present invention includes an electric wire; and a crimp terminal including a core wire crimp portion crimped to a core wire of the electric wire, wherein the core wire crimp portion includes a bottom wall portion, and a crimping piece that extends in a direction intersecting the bottom wall portion from an end of the bottom wall portion in a width direction and that is wound around the core wire, a cross-sectional shape of the crimping piece is a curved shape convex toward a side opposite to the bottom wall portion, and a curved portion of the crimping piece includes a protrusion formed to protrude stepwise with respect to surrounding portions.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a crimp terminal and an electric wire according to an embodiment;

FIG. 2 is a front view illustrating a terminal crimping device according to an embodiment;

FIG. 3 is a perspective view of an upper mold according to an embodiment;

FIG. 4 is a bottom view of an upper mold according to an embodiment;

FIG. 5 is a cross-sectional view of an upper mold according to an embodiment;

FIG. 6 is a plan view of a terminal-equipped electric wire according to an embodiment;

FIG. 7 is a side view of the terminal-equipped electric wire according to an embodiment;

FIG. 8 is a cross-sectional view of a terminal-equipped electric wire according to an embodiment;

FIG. 9 is a side view of a terminal-equipped electric wire according to a first modification of an embodiment;

FIG. 10 is a plan view of a terminal-equipped electric wire according to a second modification of an embodiment;

FIG. 11 is a side view of a terminal-equipped electric wire according to the second modification of an embodiment; and

FIG. 12 is a cross-sectional view of a terminal-equipped electric wire according to a third modification of an embodiment.

### DETAILED DESCRIPTION OF THE PREFERRED EMBODIMENTS

Hereinafter, a terminal-equipped electric wire and terminal crimping device according to an embodiment of the present invention will be described in detail with reference to the drawings. Note that the present invention is not limited by the present embodiment. Moreover, components in the following embodiment include those that can be easily assumed by those skilled in the art or substantially identical.

### Embodiment

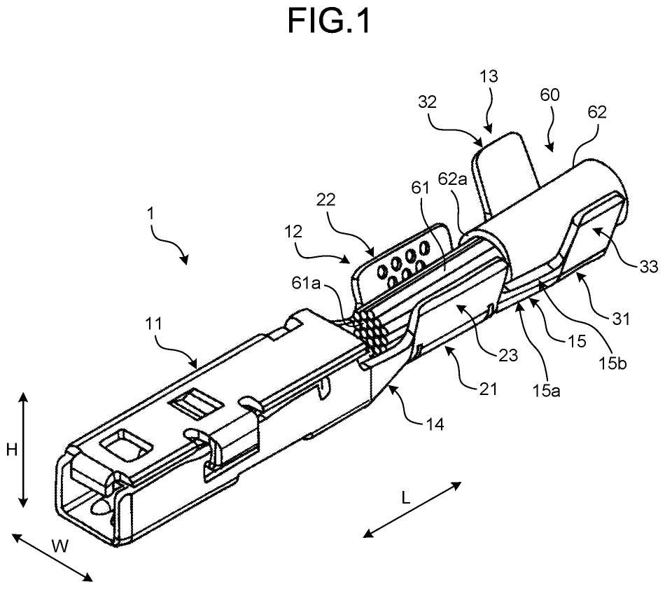

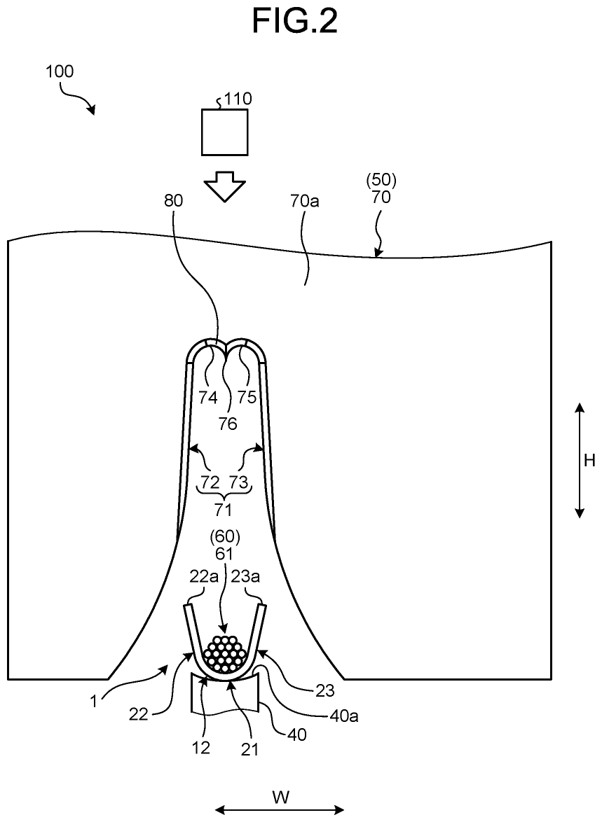

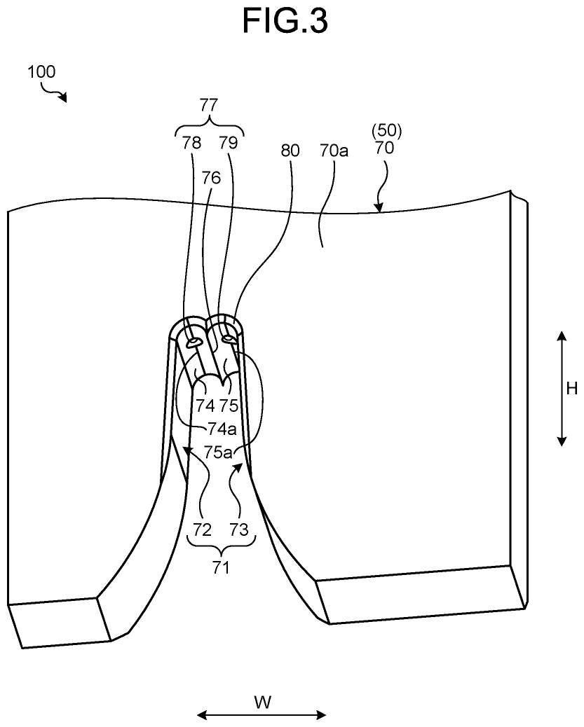

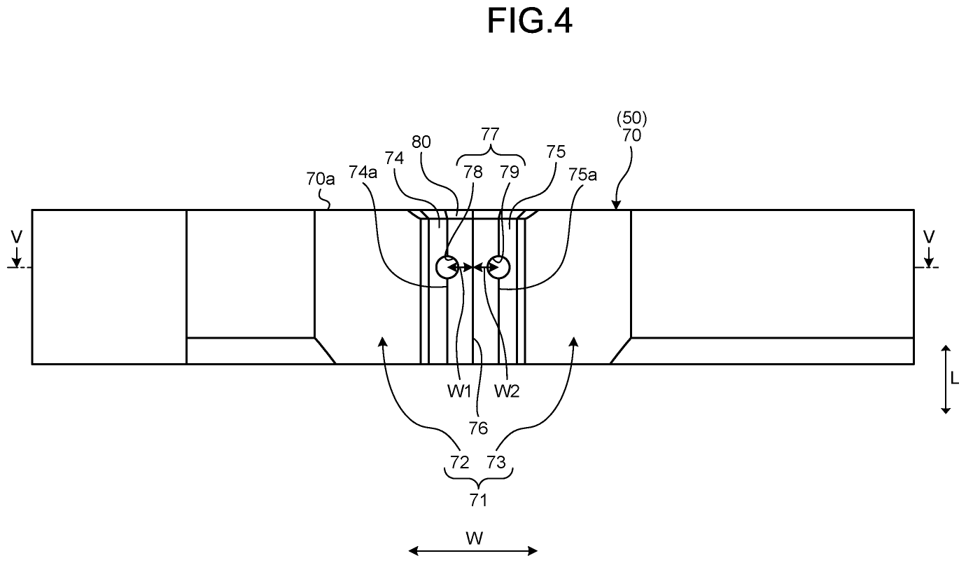

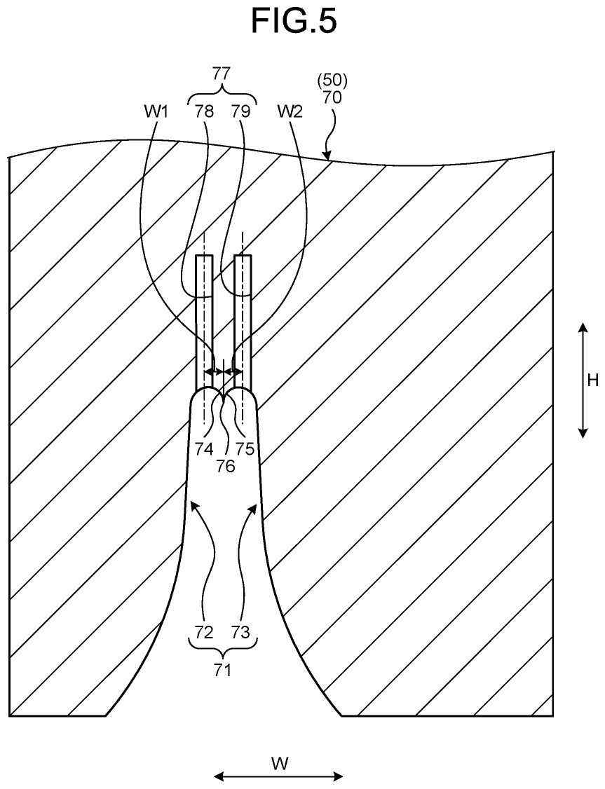

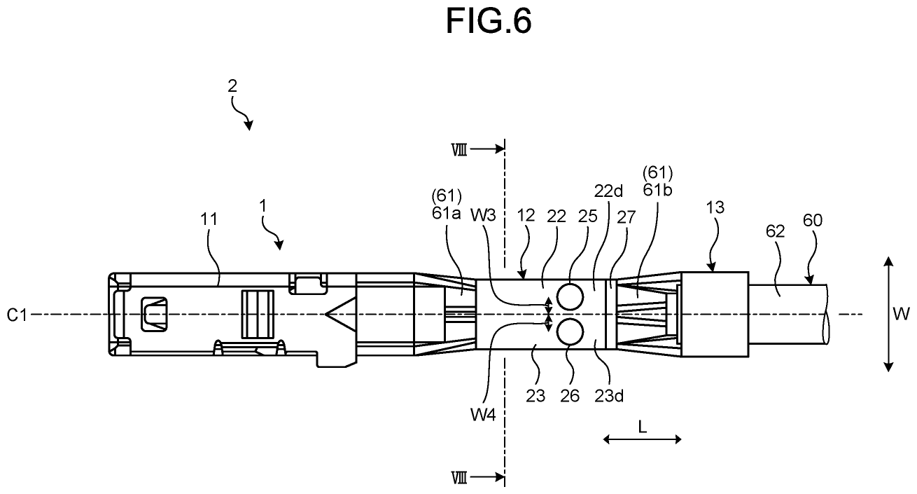

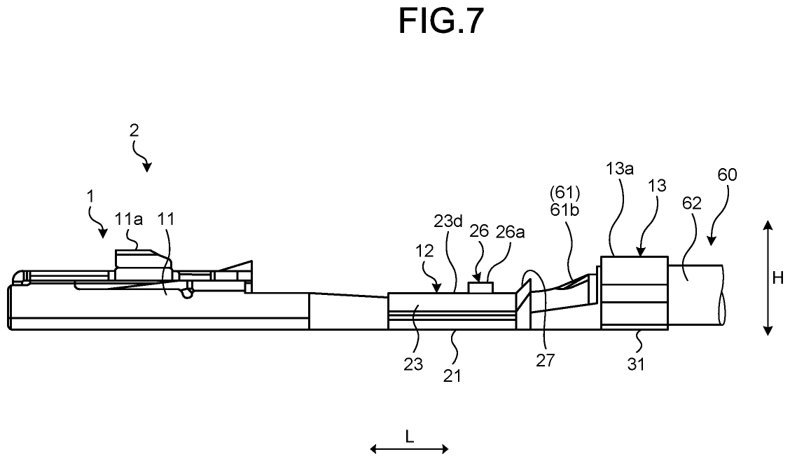

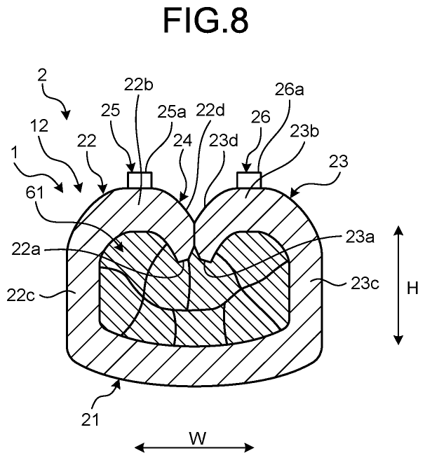

An embodiment will be described with reference to FIGS. 1 to 8. The present embodiment relates to a terminal-equipped electric wire and a terminal crimping device. FIG. 1 is a perspective view illustrating a crimp terminal and an electric wire an embodiment. FIG. 2 is a front view illustrating a terminal crimping device according to an embodiment. FIG. 3 is a perspective view of an upper mold according to an embodiment. FIG. 4 is a bottom view of an upper mold according to an embodiment. FIG. 5 is a cross-sectional view of an upper mold according to an embodiment. FIG. 6 is a plan view of a terminal-equipped electric wire according to an embodiment. FIG. 7 is a side view of a terminal-equipped electric wire according to an embodiment. FIG. 8 is a cross-sectional view of a terminal-equipped electric wire according to an embodiment. FIG. 5 illustrates a cross section taken along line V-V in FIG. 4. FIG. 8 illustrates a cross section taken along line VIII-VIII of FIG. 6.

As illustrated in FIG. 1, a crimp terminal 1 according to the present embodiment includes a terminal connecting portion 11, a core wire crimp portion 12, and a covering crimp portion 13. The terminal connecting portion 11, the core wire crimp portion 12, and the covering crimp portion 13 are arranged in this order in a longitudinal direction of the crimp terminal 1. The crimp terminal 1 is formed from a conductive metal plate (for example, a copper plate or a copper alloy plate) as a base material. The crimp terminal 1 is formed into a predetermined shape by punching or bending the base material. The surface of the crimp terminal 1 may be plated with tin (Sn) or the like.

In the description of the crimp terminal 1 in the present specification, a connection direction with the counterpart terminal, that is, an insertion direction with respect to the counterpart terminal is referred to as a first direction L. The first direction L is the longitudinal direction of the crimp terminal 1. A width direction of the crimp terminal 1 is referred to as a second direction W. The second direction W is orthogonal to the first direction L. In the crimp terminal 1, a direction orthogonal to both the first direction L and the second direction W is referred to as a third direction H. The third direction H is a compression direction by an upper mold 50 when the crimp terminal 1 is crimped. The third direction H is a height direction of the crimp terminal 1.

The terminal connecting portion 11 is a portion electrically connected to a counterpart terminal. The shape of the terminal connecting portion 11 of the present embodiment is a rectangular tube shape. The core wire crimp portion 12 is a portion that is crimped to a core wire 61 of an electric wire 60. The electric wire 60 has the core wire 61 and a covering 62. Examples of the material of the core wire 61 include copper and aluminum. In the electric wire 60 to be crimped by the crimp terminal 1, the covering 62 at the end is removed to expose the core wire 61 by a predetermined length. The core wire 61 of the present embodiment is a group of a plurality of strands. Alternatively, the core wire 61 may be a single wire such as a coaxial cable. The crimp terminal 1 is crimped to the end of the electric wire 60 and thereby electrically connected to the exposed core wire 61.

The shape of the core wire crimp portion 12 before being crimped to the core wire 61 is a U-shape as illustrated in FIG. 1. The core wire crimp portion 12 includes a bottom wall portion 21, a first crimping piece 22, and a second crimping piece 23. The bottom wall portion 21 is a portion to be a bottom wall of the core wire crimp portion 12, and is supported by a lower mold 40 described below. The first crimping piece 22 and the second crimping piece 23 are a pair of conductor crimping pieces that are crimped to the core wire 61. The first crimping piece 22 is a side wall portion extending from one end of the bottom wall portion 21 in the width direction. The second crimping piece 23 is a side wall portion extending from the other end in the width direction of the bottom wall portion 21. The first crimping piece 22 and the second crimping piece 23 extend in a direction intersecting the width direction of the bottom wall portion 21. The first crimping piece 22 and the second crimping piece 23 face each other in the second direction W. As illustrated in FIGS. 1 and 2, the distance between the first crimping piece 22 and the second crimping piece 23 increases from the bottom wall portion 21 side toward the tip side.

As illustrated in FIG. 1, the covering crimp portion 13 includes a bottom wall portion 31, a third crimping piece 32, and a fourth crimping piece 33. The shape of the covering crimp portion 13 before being crimped to the covering 62 is a U-shape as illustrated in FIG. 1. The bottom wall portion 31 is a portion to be a bottom wall of the covering crimp portion 13. The third crimping piece 32 is a side wall portion extending from one end of the bottom wall portion 31 in the width direction. The fourth crimping piece 33 is a side wall portion extending from the other end of the bottom wall portion 31 in the width direction. The third crimping piece 32 and the fourth crimping piece 33 face each other in the second direction W. The distance between the third crimping piece 32 and the fourth crimping piece 33 increases from the bottom wall portion 31 side toward the tip side. The covering crimp portion 13 is crimped to the covering 62 by the lower mold 40 and the upper mold 50.

The terminal connecting portion 11 and the core wire crimp portion 12 are connected via an intermediate portion 14. The height of the intermediate portion 14 is lower than any of the height of the terminal connecting portion 11 and the height of the core wire crimp portion 12. The core wire crimp portion 12 and the covering crimp portion 13 are connected via an intermediate portion 15. The intermediate portion 15 includes a bottom wall portion 15a and a side wall portion 15b. The bottom wall portion 15a connects the bottom wall portion 21 of the core wire crimp portion 12 and the bottom wall portion 31 of the covering crimp portion 13. The side wall portion 15b extends from both sides of the bottom wall portion 15a. One side wall portion 15b connects the first crimping piece 22 and the third crimping piece 32. The other side wall portion 15b connects the second crimping piece 23 and the fourth crimping piece 33. The height of the side wall portion 15b is lower than any of the heights of the crimping pieces 22 and 23 of the core wire crimp portion 12 and the heights of the crimping pieces 32 and 33 of the covering crimp portion 13.

As illustrated in FIG. 1, the electric wire 60 is mounted on the crimp terminal 1 such that an axial direction of the electric wire 60 is aligned with the longitudinal direction of the crimp terminal 1. In a state mounted on the crimp terminal 1, a tip 61a of the core wire 61 is directed to the terminal connecting portion 11. The core wire 61 exposed to the outside from the covering 62 is mounted on the core wire crimp portion 12. At this time, the tip 61a of the core wire 61 may protrude from the core wire crimp portion 12 to the terminal connecting portion 11 side. The covering 62 of the electric wire 60 is mounted on the covering crimp portion 13. The electric wire 60 is installed such that a tip 62a of the covering 62 is positioned between the core wire crimp portion 12 and the covering crimp portion 13, for example.

The core wire crimp portion 12 and the covering crimp portion 13 are crimped to the electric wire 60 by the lower mold 40 and the upper mold 50 as illustrated in FIG. 2. The lower mold 40 and the upper mold 50 are components of a terminal crimping device 100. The lower mold 40 is a support-side mold that supports the core wire crimp portion 12 and the covering crimp portion 13 from below. A support surface 40a of the lower mold 40 supports an outer surface of the bottom wall portion 21 of the core wire crimp portion 12. Therefore, the first crimping piece 22 and the second crimping piece 23 are in a posture extending obliquely upward from the bottom wall portion 21 in a state where the core wire crimp portion 12 is supported by the lower mold 40. The lower mold 40 supports the covering crimp portion 13 from below in a similar manner.

The upper mold 50 is a terminal crimping mold that sandwiches the crimp terminal 1 and the electric wire 60 between the lower mold 40 and oneself and thereby crimps the crimp terminal 1 to the electric wire 60. The upper mold 50 sandwiches the core wire crimp portion 12 and the core wire 61 between the lower mold 40 and oneself and thereby crimps the core wire crimp portion 12 to the core wire 61. In addition, the upper mold 50 sandwiches the covering crimp portion 13 and the covering 62 between the lower mold 40 and oneself and crimps the covering crimp portion 13 to the covering 62. As illustrated in FIG. 2, the upper mold 50 is disposed above the lower mold 40. The upper mold 50 moves relative to the lower mold 40 in the third direction H. The terminal crimping device 100 includes a driving device 110 that moves the upper mold 50 up and down in the third direction H.

The upper mold 50 of the present embodiment includes a first upper mold 70 illustrated in FIGS. 2 to 5. The first upper mold 70 is a mold for crimping the core wire crimp portion 12 to the core wire 61. Apart from the first upper mold 70, the upper mold 50 has a second upper mold (not illustrated). The second upper mold crimps the covering crimp portion 13 to the covering 62. The second upper mold moves up and down together with the first upper mold 70. The first upper mold 70 and the second upper mold may be integrated.

As illustrated in FIG. 2, the first upper mold 70 has a recessed first crimping surface 71. The first crimping surface 71 is a groove-like recessed surface provided on the lower surface of the first upper mold 70. The first upper mold 70 of the present embodiment crimps the core wire crimp portion 12 to the core wire 61 by a B-type crimping method (refer to FIG. 8). As illustrated in FIG. 2, the first crimping surface 71 has a first wall surface 72 and a second wall surface 73. The first wall surface 72 and the second wall surface 73 face each other in the second direction W.

The first wall surface 72 and the second wall surface 73 are positioned away from each other downward in the third direction H. The upper end portion of the first wall surface 72 includes a first curved surface 74. The upper end portion of the second wall surface 73 includes a second curved surface 75. The first curved surface 74 and the second curved surface 75 are surfaces facing the lower mold 40 in the third direction H, and are curved upward. The first curved surface 74 and the second curved surface 75 are located in an inner part of the first wall surface 72 and the second wall surface 73 farthest from the lower mold 40. The first curved surface 74 and the second curved surface 75 are adjacent in the second direction W. The boundary between the first curved surface 74 and the second curved surface 75 forms a ridge 76 projecting downward.

As illustrated in FIGS. 3 and 4, the first curved surface 74 and the second curved surface 75 have boundary portions 74a and 75a, respectively. The boundary portions 74a and 75a are boundary lines at which the curvature changes. The radius of curvature of the first curved surface 74 changes at the boundary portion 74a. That is, the magnitude of the radius of curvature of the first curved surface 74 differs between the portion on one side in the second direction W and the portion on the other side in the second direction W across the boundary portion 74a. In the first curved surface 74, the radius of curvature of the portion on the ridge 76 side of the boundary portion 74a may be relatively small.

The magnitude of the radius of curvature of the second curved surface 75 differs between the portion on one side in the second direction W and the portion on the other side in the second direction W across the boundary portion 75a. In the second curved surface 75, the radius of curvature of the portion on the ridge 76 side of the boundary portion 75a may be relatively small.

The first curved surface 74 bends the first crimping piece 22 toward the second curved surface 75 and winds the first crimping piece 22 around the core wire 61. The second curved surface 75 bends the second crimping piece 23 toward the first curved surface 74 and winds the second crimping piece 23 around the core wire 61. This procedure forms a terminal-equipped electric wire 2 illustrated in FIGS. 6 to 8. In a crimping process, the core wire crimp portion 12 is crimped to the core wire 61 so as to be electrically connected to the core wire 61. In the crimping process, the covering crimp portion 13 is crimped to the covering 62 to hold the covering 62. As illustrated in FIGS. 6 and 7, an intermediate exposed portion 61b of the core wire 61 is exposed to the external space between the core wire crimp portion 12 and the covering crimp portion 13. The tip 61a of the core wire 61 protrudes from the core wire crimp portion 12 toward the terminal connecting portion 11 side.

The first upper mold 70 of the present embodiment has a recess 77 as illustrated in FIGS. 3 to 5. The recess 77 is provided on the first crimping surface 71 of the first upper mold 70. The recess 77 is recessed stepwise with respect to surrounding portions. In other words, the recess 77 is depressed with respect to the surrounding portions of the recess 77. The recess 77 includes a first recess 78 and a second recess 79. The first recess 78 is provided on the first curved surface 74 of the first wall surface 72. That is, the first recess 78 is disposed in a portion of the first wall surface 72, facing the lower mold 40 in the third direction H. The second recess 79 is provided on the second curved surface 75 of the second wall surface 73. That is, the second recess 79 is disposed in a portion of the second wall surface 73 facing the lower mold 40 in the third direction H. The first recess 78 and the second recess 79 extend in the third direction H.

The first recess 78 and the second recess 79 according to the present embodiment have shapes each having a cylindrical space inside. That is, each of the first recess 78 and the second recess 79 has a circular cross-sectional shape of the section orthogonal to a depth direction. The cross-sectional shape of the first recess 78 and the cross-sectional shape of the second recess 79 are the same shape or substantially the same, for example. The depth of the first recess 78 is same as the depth of the second recess 79, for example.

The first recess 78 and the second recess 79 are adjacent in the width direction, that is, the second direction W. The center position of the first recess 78 in the first direction L may be the same as the center position of the second recess 79 in the first direction L. In the present embodiment, as illustrated in FIGS. 4 and 5, a distance W1 from the tip of the ridge 76 to the central axis of the first recess 78 is equal to a distance W2 from the tip of the ridge 76 to the central axis of the second recess 79. Each of the distance W1 and the distance W2 is a distance in the second direction W. That is, the first recess 78 and the second recess 79 are arranged line-symmetrically with respect to the tip of the ridge 76. For example, the first recess 78 is arranged such that the central axis of the first recess 78 is located at the boundary portion 74a. For example, the second recess 79 is arranged such that the central axis of the second recess 79 is located at the boundary portion 75a.

The first crimping surface 71 includes an inclined end surface 80. The inclined end surface 80 is provided at one end of the first crimping surface 71 in the first direction L. The inclined end surface 80 is inclined with respect to the first direction L and spreads in the first direction L toward a main surface 70a. The main surface 70a is one of a pair of main surfaces of the first upper mold 70 and is orthogonal to the first direction L. The main surface 70a is a surface facing the covering 62 side of the electric wire 60 in the crimping process. In other words, the main surface 70a is a surface located on the base side of the core wire 61 in the crimping process. The recess 77 is provided at a position near the main surface 70a in the first direction L, for example. The recess 77 is arranged so as not to overlap the inclined end surface 80.

As illustrated in FIG. 8, the core wire crimp portion 12 is crimped to the core wire 61 in a substantially B shape. The cross-sectional shape of each of the first crimping piece 22 and the second crimping piece 23 after crimping is a curved shape convex toward the side opposite to the bottom wall portion 21 side. More specifically, the first crimping piece 22 has a curved portion 22b and a base portion 22c. The base portion 22c is a portion extending from the bottom wall portion 21 in the third direction H. The cross-sectional shape of the base portion 22c is a substantially linear shape. The curved portion 22b is a portion on the tip side of the base portion 22c in the first crimping piece 22. The curved portion 22b is curved such that a tip 22a faces the bottom wall portion 21 in the third direction H.

The second crimping piece 23 includes a curved portion 23b and a base portion 23c. The base portion 23c is a portion extending from the bottom wall portion 21 in the third direction H. The cross-sectional shape of the base portion 23c is a substantially linear shape. The curved portion 23b is a portion on the tip side of the base portion 23c in the second crimping piece 23. The curved portion 23b is curved such that a tip 23a faces the bottom wall portion 21 in the third direction H. The first crimping piece 22 and the second crimping piece 23 are crimped to the core wire 61 while bringing an outer surface 22d of the first crimping piece 22 and an outer surface 23d of the second crimping piece 23 into contact with each other. A portion where the first crimping piece 22 and the second crimping piece 23 come in contact is formed into a groove 24. The groove 24 is a groove-shaped portion formed between the curved portions 22b and 23b, and extends in the first direction L.

As illustrated in FIGS. 6 to 8, in the terminal-equipped electric wire 2 of the present embodiment includes protrusions 25 and 26 respectively formed on the first crimping piece 22 and the second crimping piece 23. The first protrusion 25 is a protrusion arranged on the outer surface 22d of the first crimping piece 22. The first protrusion 25 protrudes stepwise with respect to surrounding portions on the outer surface 22d. The first protrusion 25 is formed at a top of the curved shape of the first crimping piece 22, for example. The second protrusion 26 is a protrusion arranged on the outer surface 23d of the second crimping piece 23. The second protrusion 26 protrudes stepwise with respect to surrounding portions on the outer surface 23d. The second protrusion 26 is formed at a top of the curved shape of the second crimping piece 23, for example.

The first protrusion 25 and the second protrusion 26 protrude toward the side opposite to the bottom wall portion 21. The protruding direction of each of the first protrusion 25 and the second protrusion 26 is the third direction H, that is, a height direction of the crimp terminal 1. The first protrusion 25 and the second protrusion 26 may protrude in a direction slightly inclined with respect to the third direction H.

The first protrusion 25 and the second protrusion 26 are formed in the crimping process. In the crimping process, the core wire crimp portion 12 is crimped to the core wire 61 by the upper mold 50 and the lower mold 40. A part of the core wire crimp portion 12 enters the recess 77 when the core wire crimp portion 12 is crimped, whereby the first protrusion 25 and the second protrusion 26 are formed. A part of the first crimping piece 22 enters the first recess 78 in the crimping process, whereby the first protrusion 25 is formed. A part of the second crimping piece 23 enters the second recess 79 in the crimping process, whereby the second protrusion 26 is formed. Entrance of the part of the core wire crimp portion 12 into the recess 77 suppresses the lengthening of the crimp terminal 1 in the crimping process. Accordingly, the terminal-equipped electric wire 2 of the present embodiment can reduce the amount of lengthening of the crimp terminal 1, and can suppress variation in the amount of lengthening. According to the terminal-equipped electric wire 2 of the present embodiment, it is possible to suppress a situation in which the crimp terminal 1 jumps out of a cavity such as an electric junction box.

As illustrated in FIGS. 6 to 8, the first protrusion 25 and the second protrusion 26 of the present embodiment have cylindrical shapes. Each of the first protrusion 25 and the second protrusion 26 has a circular cross-sectional shape in a cross section orthogonal to the protrusion direction. The cross-sectional shape of the first protrusion 25 and the cross-sectional shape of the second protrusion 26 may have a same shape or substantially the same, for example. The protruding height of the first protrusion 25 and the protruding height of the second protrusion 26 are the same, for example.

As illustrated in FIG. 7, a tip 26a of the second protrusion 26 is located at a position lower than a top 13a of the covering crimp portion 13. That is, a distance in the third direction H from the bottom wall portion 21 to the tip 26a is shorter than a distance in the third direction H from the bottom wall portion 31 to the top 13a. The tip 26a is located at a position lower than a top 11a of the terminal connecting portion 11. The height position of a tip 25a (refer to FIG. 8) of the first protrusion 25 is substantially the same as the height position of the tip 26a. That is, the tip 25a is at a position lower than any of the top 13a of the covering crimp portion 13 and the top 11a of the terminal connecting portion 11. Accordingly, the two protrusions 25 and 26 would not easily interfere with the wall surface of a cavity when the crimp terminal 1 is stored in the cavity.

The first protrusion 25 and the second protrusion 26 face each other in the width direction, that is, the second direction W. The center position of the first protrusion 25 in the first direction L may be the same as the center position of the second protrusion 26 in the first direction L. In the present embodiment, as illustrated in FIG. 6, a distance W3 from a center line Cl of the terminal-equipped electric wire 2 to the center of the first protrusion 25 is equal to a distance W4 from the center line Cl to the center of the second protrusion 26. That is, in a plan view of the terminal-equipped electric wire 2, the first protrusion 25 and the second protrusion 26 are arranged line-symmetrically with respect to the center line Cl.

The positions of the first protrusion 25 and the second protrusion 26 in the first direction L may be a position on the covering crimp portion 13 side of the center of the core wire crimp portion 12, or may be a position on the terminal connecting portion 11 side of the center, for example. The first protrusion 25 and the second protrusion 26 are preferably formed in a region excluding a bell-mouth portion 27 in the core wire crimp portion 12. The bell-mouth portion 27 is a portion formed corresponding to the inclined end surface 80 of the first upper mold 70. The bell-mouth portion 27 is formed at the covering crimp portion 13-side end of the core wire crimp portion 12. The outer surface of the bell-mouth portion 27 is an inclined surface that is inclined with respect to the first direction L. The bell-mouth portion 27 is inclined so as to expand in the first direction L toward the covering crimp portion 13.

The first protrusion 25 of the present embodiment is formed in a region excluding the bell-mouth portion 27 in the first crimping piece 22. The second protrusion 26 is formed in a region excluding the bell-mouth portion 27 in the second crimping piece 23. In order to arrange the first protrusion 25 and the second protrusion 26 in this manner, the recess 77 is separated from the inclined end surface 80 as illustrated in FIG. 4 or the like. That is, the recess 77 is formed in a region excluding the inclined end surface 80 on the first curved surface 74 and the second curved surface 75.

As described above, the terminal-equipped electric wire 2 of the present embodiment includes the electric wire 60 and the crimp terminal 1. The crimp terminal 1 includes the core wire crimp portion 12 that is crimped to the core wire 61 of the electric wire 60. The core wire crimp portion 12 includes the bottom wall portion 21 and the crimping pieces 22 and 23. The crimping pieces 22 and 23 extend in a direction intersecting the bottom wall portion 21 from the end of the bottom wall portion 21 in the second direction W, and are wound around the core wire 61.

The cross-sectional shape of each of the crimping pieces 22 and 23 is a curved shape that is convex toward the side opposite to the bottom wall portion 21. The curved portions 22b and 23b of the crimping pieces 22 and 23 respectively include the protrusions 25 and 26 protruding stepwise with respect to surrounding portions. In the crimp terminal 1 in which the protrusions 25 and 26 are formed, the lengthening of the crimp terminal 1 is suppressed in the crimping process. Since the volume corresponding to the protrusions 25 and 26 is released, the lengthening of the crimp terminal 1 in the first direction L is suppressed. Accordingly, the terminal-equipped electric wire 2 of the present embodiment achieves an effect that the lengthening of the crimp terminal due to crimping is suppressed. Furthermore, since the lengthening of the crimp terminal 1 is suppressed, it is possible to reduce variation in the length of the crimp terminal 1 in the first direction L.

In the terminal-equipped electric wire 2 of the present embodiment, the bell-mouth portions 27 are formed at the end portions in the first direction L of the crimping pieces 22 and 23. The protrusions 25 and 26 are formed in regions excluding the bell-mouth portion 27 in the crimping pieces 22 and 23. In the embodiment, the protrusions 25 and 26 are formed in a region on the terminal connecting portion 11 side of the bell-mouth portion 27 in the first direction L. Forming the protrusions 25 and 26 in the region excluding the bell-mouth portion 27 would prevent interference between the formation of the bell-mouth portion 27 and the formation of the protrusions 25 and 26.

The crimping pieces 22 and 23 of the present embodiment include the first crimping piece 22 and the second crimping piece 23. The first crimping piece 22 extends from one end of the bottom wall portion 21 in the width direction, while the second crimping piece 23 extends from the other end of the bottom wall portion 21 in the width direction. The core wire crimp portion 12 is crimped to the core wire 61 while bringing the outer surface 22d of the first crimping piece 22 and the outer surface 23d of the second crimping piece 23 into contact with each other. The protrusions 25 and 26 include the first protrusion 25 formed on the outer surface 22d of the first crimping piece 22 and the second protrusion 26 formed on the outer surface 23d of the second crimping piece 23. The first protrusion 25 and the second protrusion 26 face each other in the width direction of the bottom wall portion 21. This ensures symmetry in the crimp terminal 1, leading to reduction of variations in the performance of the crimp terminal 1. For example, it is possible to reduce the variation between the amount of lengthening on the first crimping piece 22 side and the amount of lengthening on the second crimping piece 23 side.

The crimp terminal 1 of the present embodiment has the covering crimp portion 13 that is crimped to the covering 62 of the electric wire 60. In the height direction of the crimp terminal 1, the tips 25a and 26a of the protrusions 25 and 26 are located lower than the top 13a of the covering crimp portion 13. Therefore, the protrusions 25 and 26 would not easily interfere with the cavity when the crimp terminal 1 is stored in the cavity.

The terminal crimping device 100 according to the present embodiment includes the lower mold 40 and the upper mold 50. The lower mold 40 supports the crimp terminal 1 having the core wire crimp portion 12 crimped to the core wire 61 of the electric wire 60, from below. The upper mold 50 has the first crimping surface 71 for winding the core wire crimp portion 12 around the core wire 61, and descending toward the lower mold 40 to crimp the crimp terminal 1 to the electric wire 60. In the first crimping surface 71, the portion facing the lower mold 40 has the recess 77 that is recessed stepwise with respect to the surrounding portion. In the embodiment, the first curved surface 74 and the second curved surface 75 have the recess 77. The upper mold 50 including the recess 77 can release a part of the core wire crimp portion 12 to the recess 77 in the crimping process, making is possible to suppress the lengthening of the crimp terminal 1.

### First Modification of Embodiment

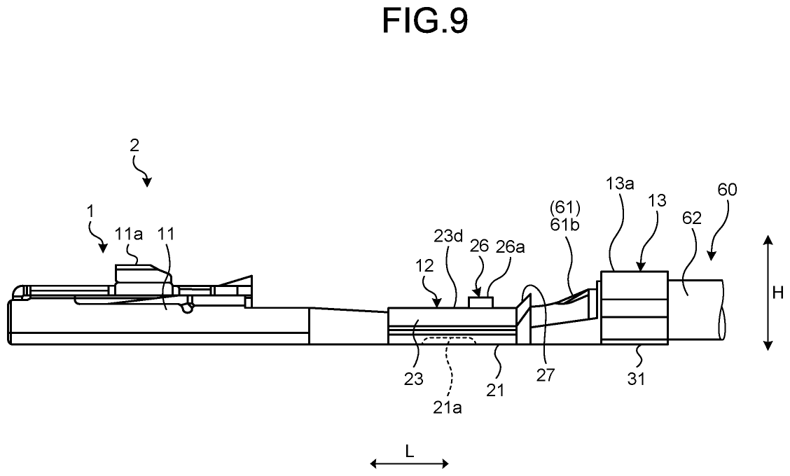

A first modification of an embodiment will be described. FIG. 9 is a side view of a terminal-equipped electric wire according to the first modification of an embodiment. The terminal-equipped electric wire 2 illustrated in FIG. 9 has a recess 21a in the bottom wall portion 21. The recess 21a is formed by the lower mold 40 in the crimping process, for example. In this case, the lower mold 40 having a protrusion on the support surface 40a is used in the crimping process. The recess 21a extends in the first direction L. The recess 21a is formed in the center portion of the bottom wall portion 21 in the second direction W, for example.

In a case where the recess 21a is formed in the bottom wall portion 21, the first protrusion 25 and the second protrusion 26 are preferably arranged so as not to overlap the recess 21a. The first protrusion 25 and the second protrusion 26 are formed at a position on the covering crimp portion 13 side of the recess 21a. The first protrusion 25 and the second protrusion 26 may be formed at a position on the terminal connecting portion 11 side of the recess 21a. Since there is no overlapping between the position of the recess 21a and the position of the protrusions 25 and 26 in the first direction L, it is possible to suppress the reduction in strength of the core wire crimp portion 12.

### Second Modification of Embodiment

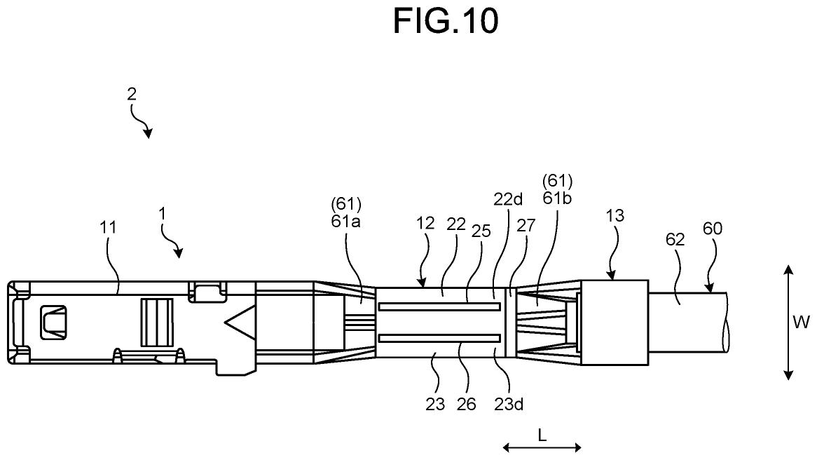

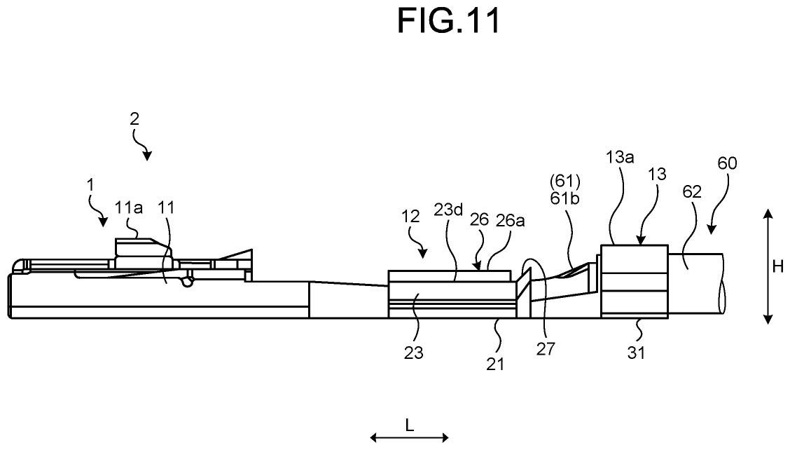

A second modification of an embodiment will be described. FIG. 10 is a plan view of a terminal-equipped electric wire according to the second modification of an embodiment. FIG. 11 is a side view of the terminal-equipped electric wire according to the second modification of an embodiment. The second modification of an embodiment differs from the above embodiment in the shape of the protrusions 25 and 26, for example.

As illustrated in FIGS. 10 and 11, the protrusions 25 and 26 according to the second modification of the embodiment extend in the first direction L. For example, the first protrusion 25 and the second protrusion 26 are formed in the first direction L from one end to the other end of the core wire crimp portion 12 excluding the bell-mouth portion 27. The cross-sectional shape of the protrusions 25 and 26 in the cross section orthogonal to the first direction L is a rectangle, for example. The cross-sectional shape of the protrusions 25 and 26 may be trapezoidal or semicircular. Forming the first protrusion 25 and the second protrusion 26 in a wide range in the first direction L makes it possible to increase the volume of the first protrusion 25 and the second protrusion 26. Accordingly, with the terminal-equipped electric wire 2 according to the second modification of the embodiment, it is possible to suppress the lengthening of the crimp terminal 1.

### Third Modification of Embodiment

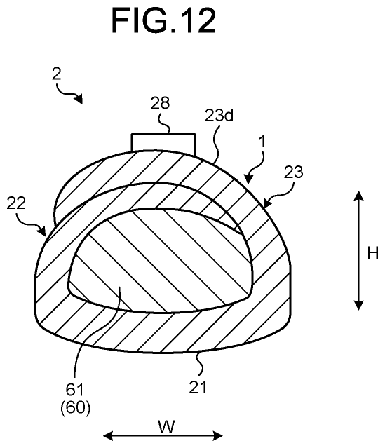

A third modification of an embodiment will be described. FIG. 12 is a cross-sectional view of a terminal-equipped electric wire according to the third modification of an embodiment. The third modification of an embodiment differs from the above embodiment in that the first crimping piece 22 and the second crimping piece 23 are crimped while overlapping each other.

As illustrated in FIG. 12, the first crimping piece 22 and the second crimping piece 23 are wound around the core wire 61 while overlapping each other. In the crimp terminal 1 of the present modification, the first crimping piece 22 and the second crimping piece 23 integrally cover the core wire 61 from the tip 61a to the covering 62. That is, the core wire crimp portion 12 and the covering crimp portion 13 of the above embodiment are integrated.

For example, the crimp terminal 1 is crimped to the core wire 61 so that the second crimping piece 23 overlaps the outside of the first crimping piece 22. In this case, for example, a protrusion 28 is formed on the second crimping piece 23 positioned on the outside. The protrusion 28 is formed at a top of the second crimping piece 23, for example. In other words, the protrusion 28 may be formed at a position farthest from the bottom wall portion 21 on the outer surface 23d of the second crimping piece 23. The protrusion 28 may be formed in plurality on the second crimping piece 23.

### Fourth Modification of Embodiment

A fourth modification of an embodiment will be described. An anticorrosion resin film may be formed on the terminal-equipped electric wire 2. The resin film is formed so as to cover the tip 61a of the core wire 61 and the intermediate exposed portion 61b, for example. The resin film may be further formed in the groove 24 of the core wire crimp portion 12.

The shape, arrangement, number, or the like, of the protrusions are not limited to the shape, arrangement, number, or the like, of the protrusions 25, 26, or 28 exemplified in the above embodiment and the modification. The shape, arrangement, number, or the like, of the protrusions are appropriately determined in accordance with the crimped shape of the crimp terminal 1 with respect to the electric wire 60.

The contents disclosed in the above embodiments and modifications can be executed in appropriate combination with each other.

In the terminal-equipped electric wire according to the present embodiment, a protrusion protruding stepwise with respect to surrounding portions is formed on a curved portion of a crimping piece. According to the terminal-equipped electric wire of the present embodiment, it is possible to achieve an effect of releasing the volume corresponding to the protrusion formed at the time of crimping, leading to suppression of the lengthening of the crimp terminal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal-equipped electric wire comprising:
an electric wire; and
a crimp terminal including a core wire crimp portion crimped to a core wire of the electric wire, wherein
the core wire crimp portion includes
a bottom wall portion, and
a crimping piece that extends in a direction intersecting the bottom wall portion from an end of the bottom wall portion in a width direction and that is wound around the core wire,
a cross-sectional shape of the crimping piece is a curved shape convex toward a side opposite to the bottom wall portion, and
a curved portion of the crimping piece includes a protrusion formed to protrude stepwise with respect to surrounding portions.

2. The terminal-equipped electric wire according to claim 1, wherein
the protrusion is formed at a top of the curved shape of the crimping piece.

3. The terminal-equipped electric wire according to claim 1, wherein
a protruding direction of the protrusion is a direction toward a side opposite to the bottom wall portion in a height direction of the crimp terminal.

4. The terminal-equipped electric wire according to claim 2, wherein
a protruding direction of the protrusion is a direction toward a side opposite to the bottom wall portion in a height direction of the crimp terminal.

5. The terminal-equipped electric wire according to claim 1, wherein
a bell-mouth portion is formed at an end in an axial direction of the electric wire on the crimping piece, and
the protrusion is formed in a region excluding the bell-mouth portion on the crimping piece.

6. The terminal-equipped electric wire according to claim 2, wherein
a bell-mouth portion is formed at an end in an axial direction of the electric wire on the crimping piece, and
the protrusion is formed in a region excluding the bell-mouth portion on the crimping piece.

7. The terminal-equipped electric wire according to claim 3, wherein
a bell-mouth portion is formed at an end in an axial direction of the electric wire on the crimping piece, and
the protrusion is formed in a region excluding the bell-mouth portion on the crimping piece.

8. The terminal-equipped electric wire according to claim 4, wherein
a bell-mouth portion is formed at an end in an axial direction of the electric wire on the crimping piece, and
the protrusion is formed in a region excluding the bell-mouth portion on the crimping piece.

9. The terminal-equipped electric wire according to claim 1, wherein
the crimping piece includes
a first crimping piece extending from one end of the bottom wall portion in the width direction, and
a second crimping piece extending from the other end of the bottom wall portion in the width direction,
the core wire crimp portion is crimped to the core wire while bringing an outer surface of the first crimping piece and an outer surface of the second crimping piece into contact with each other,
the protrusion includes
a first protrusion formed on the outer surface of the first crimping piece, and
a second protrusion formed on the outer surface of the second crimping piece, and
the first protrusion and the second protrusion face each other in the width direction of the bottom wall portion.

10. The terminal-equipped electric wire according to claim 2, wherein
the crimping piece includes
a first crimping piece extending from one end of the bottom wall portion in the width direction, and
a second crimping piece extending from the other end of the bottom wall portion in the width direction,
the core wire crimp portion is crimped to the core wire while bringing an outer surface of the first crimping piece and an outer surface of the second crimping piece into contact with each other,
the protrusion includes
a first protrusion formed on the outer surface of the first crimping piece, and
a second protrusion formed on the outer surface of the second crimping piece, and
the first protrusion and the second protrusion face each other in the width direction of the bottom wall portion.

11. The terminal-equipped electric wire according to claim 3, wherein
the crimping piece includes
a first crimping piece extending from one end of the bottom wall portion in the width direction, and
a second crimping piece extending from the other end of the bottom wall portion in the width direction,
the core wire crimp portion is crimped to the core wire while bringing an outer surface of the first crimping piece and an outer surface of the second crimping piece into contact with each other,
the protrusion includes
a first protrusion formed on the outer surface of the first crimping piece, and
a second protrusion formed on the outer surface of the second crimping piece, and
the first protrusion and the second protrusion face each other in the width direction of the bottom wall portion.

12. The terminal-equipped electric wire according to claim 4, wherein
the crimping piece includes
a first crimping piece extending from one end of the bottom wall portion in the width direction, and
a second crimping piece extending from the other end of the bottom wall portion in the width direction,
the core wire crimp portion is crimped to the core wire while bringing an outer surface of the first crimping piece and an outer surface of the second crimping piece into contact with each other,
the protrusion includes
a first protrusion formed on the outer surface of the first crimping piece, and
a second protrusion formed on the outer surface of the second crimping piece, and
the first protrusion and the second protrusion face each other in the width direction of the bottom wall portion.

13. The terminal-equipped electric wire according to claim 5, wherein
the crimping piece includes
a first crimping piece extending from one end of the bottom wall portion in the width direction, and
a second crimping piece extending from the other end of the bottom wall portion in the width direction,
the core wire crimp portion is crimped to the core wire while bringing an outer surface of the first crimping piece and an outer surface of the second crimping piece into contact with each other,
the protrusion includes
a first protrusion formed on the outer surface of the first crimping piece, and
a second protrusion formed on the outer surface of the second crimping piece, and
the first protrusion and the second protrusion face each other in the width direction of the bottom wall portion.

14. The terminal-equipped electric wire according to claim 6, wherein
the crimping piece includes
a first crimping piece extending from one end of the bottom wall portion in the width direction, and
a second crimping piece extending from the other end of the bottom wall portion in the width direction,
the core wire crimp portion is crimped to the core wire while bringing an outer surface of the first crimping piece and an outer surface of the second crimping piece into contact with each other,
the protrusion includes
a first protrusion formed on the outer surface of the first crimping piece, and
a second protrusion formed on the outer surface of the second crimping piece, and
the first protrusion and the second protrusion face each other in the width direction of the bottom wall portion.

15. The terminal-equipped electric wire according to claim 1, wherein
the crimp terminal includes a covering crimp portion crimped to a covering of the electric wire, and
a tip of the protrusion is at a position lower than a top of the covering crimp portion in the height direction of the crimp terminal.

16. The terminal-equipped electric wire according to claim 2, wherein
the crimp terminal includes a covering crimp portion crimped to a covering of the electric wire, and
a tip of the protrusion is at a position lower than a top of the covering crimp portion in the height direction of the crimp terminal.

17. The terminal-equipped electric wire according to claim 3, wherein
the crimp terminal includes a covering crimp portion crimped to a covering of the electric wire, and
a tip of the protrusion is at a position lower than a top of the covering crimp portion in the height direction of the crimp terminal.

18. The terminal-equipped electric wire according to claim 5, wherein
the crimp terminal includes a covering crimp portion crimped to a covering of the electric wire, and
a tip of the protrusion is at a position lower than a top of the covering crimp portion in the height direction of the crimp terminal.

19. The terminal-equipped electric wire according to claim 9, wherein
the crimp terminal includes a covering crimp portion crimped to a covering of the electric wire, and
a tip of the protrusion is at a position lower than a top of the covering crimp portion in the height direction of the crimp terminal.

20. A terminal crimping device comprising:
a lower mold that supports a crimp terminal from below, the crimp terminal having a core wire crimp portion that is crimped to a core wire of an electric wire; and
an upper mold having a first crimping surface for winding the core wire crimp portion around the core wire and configured to descend toward the lower mold to crimp the crimp terminal to the electric wire, wherein
a portion facing the lower mold in the first crimping surface has a recess that is recessed stepwise with respect to surrounding portions.
